(19) United States
(12) Patent Application Publication
(10) Pub. No.: US 2003/0043200 A1
(43) Pub. Date: Mar. 6, 2003

(54) Interactive multi-level mapping in a multiple browser environment

(75) Inventors: Baldo Faieta, San Francisco, CA (US); Yin Yin Wong, San Francisco, CA (US); Lalit Balchandani, San Francisco, CA (US); Ishantha Lokuge, Pacheco, CA (US); Derek Chung, San Francisco, CA (US)

Correspondence Address: Lalit Balchandani, #151, 3288 21st ST, San Francisco, CA, 94110, US

(73) Assignee: URBANPIXEL INC, SAN FRANCISCO, CA

(21) Appl. No.: 10/216,022

(22) Filed: Aug. 9, 2002

Related U.S. Application Data
(60) Provisional application No. 60/311,417, filed on Aug. 9, 2001.

(51) Int. Cl. G09G 5/00

(52) U.S. Cl. 345/804

(57) ABSTRACT

A web browsing environment that provides for visual and interactive mapping techniques to enable users to organize, visualize and navigate complex information spaces. The Urbanpixel system supports atomic units of information organized into a tiled browser environment. The system's mapping technology allows the information environment to be surfaced into a global, active map view. Because the system supports a process of data abstraction and the use of stylesheets to create multiple views, users can drill down on areas of interest to get views at multiple levels of detail and abstraction. The navigation model keeps a one-to-one spatial correspondence between the levels, making it easier for users to find their way around by providing spatial context at every level.

### RELATED APPLICATION DATA

The present application is related to U.S. patent application Ser. No. 09/596,305 (Attorney Docket No. URBAP001), naming Wong et al. as inventors, and filed Jun. 14, 2000. That application is incorporated herein by reference in its entirety for all purposes.

The present application claims priority under 35 U.S.C./119 to U.S. Provisional Application Serial No. 60/311,417 (Attorney Docket No. URBAP005P), naming Wong et al. as inventors, and filed Aug. 9, 2001. A copy of the U.S. Provisional Application Serial No. 60/311,417 is attached hereto as Appendix A, and is incorporated herein by reference in its entirety for all purposes.

This application is related to U.S. Patent Application No. 60/297,206 (Attorney Docket No. URBAP004) entitled, INTELLIGENT BROWSER WINDOWS IN A MULTI-BROWSER ENVIRONMENT, which is incorporated by reference herein in its entirety and for all purposes.

### BACKGROUND OF THE INVENTION

The present invention relates to browsing and interacting in a computer network environment. In particular, the invention relates to novel computer network user interface techniques and associated systems and applications techniques for making the process to browse, monitor and view data elements from a data network more efficient.

Current organizations amass large numbers of data and information in order to run their everyday operations. They collect and record all kind of information and data about their customers and their behaviors; they keep track of a myriad of information about their products and their performance; they manage all internal operations by keeping data about as simple as a catalog of capital goods to as complicated as a job tracking systems that records and updates every stage of the candidate applications.

With the advent of the Internet, this data and information has been made accessible not only to every member and partner of the organization but also to the public in general. Corporate as well as public organizations list all kind of documents, products, job descriptions, etc. in their web sites. They also make accessible, for example, data they hold about customers, such as personal information as well as transactional data. Internally, within organizations, through the use of Intranets, employees may access all this data either in raw format, or processed so as to be efficient to their job functions.

The data itself that is being browsed usually correspond to a specific atomic unit such as a document, a web site, a job description, a customer, a transaction, a product, etc. As it is the case with this data, there is usually thousands and even millions of records that a user might have to navigate through in order to find and understand the information he is looking for.

Currently there are two common approaches in order to present information to a user browsing it. The first one, found very often in most of the web sites, is to organize the atomic units in a hierarchy of abstractions. So, for example, if a user is looking for a particular product, say a digital camera with particular characteristics, among many thousands of products that might be available, he or she might have to navigate down a hierarchy of product abstractions by drilling through first say electronics, and then digital devices, then digital cameras, and then through a particular types of them.

This process is efficient when the user knows what he is looking for and understands the abstraction that has been created. However, there are many problems with this approach. Indeed, if what the user is looking for is scattered among different categories or when they do not really are familiar with the abstractions then the user is at a loss. When atomic units are scattered among different categories, the user has a hard time grouping them in one view and has to rely in his memory to compare and discriminate among the information. When the abstractions are not familiar, the user has to drill to the specific details of the atomic units to understand the dimensions and what the abstraction mean. This creates another problem for the user as he has to keep in his head a picture of the hierarchy being browsed and where to find what he has seen before.

The second common approach to present information is to let users specify search criteria and return a ranked list of atomic units that matches the search criteria. The user would then look at a description of the search results and view the details of the atomic units that he might consider relevant. This approach is very efficient if the user can narrow down, through the search criteria, to a small set the records returned. However, this approach also has problems because if the search criteria is too under specified, systems often return a lot of results, and the user might get to see a description of say the top 1% of them. The user does not really have a map of the search results in order to understand how they might be organized and maybe cross correlate it with other criteria.

Against this backdrop, it will be appreciated that there exists an ongoing desire to improve the process by which users view and browse data and that address the problems described above.

### SUMMARY OF THE INVENTION

The present invention provides mechanisms for enabling a new type of interactive data-centric application where users can look at sets of data elements graphically at multiple levels of detail and multiple levels of abstraction. Data elements organized by their type of information that they represent (such as documents, jobs, customers, etc.), are seen as a set and this set is operated through the visual and interactive techniques as described herein. In accordance to techniques of the present invention, all the data elements would be shown spatially in one view overlaying the hierarchical organization as packed rectangular tiles.

Users could zoom in through this view showing progressively more informational details of the data elements shown in a graphical manner and in this way discriminate among data elements without having to go to every data element and look at all the details. Users can also drill through the hierarchical organization of the set, while still looking at the subsets of the subcategories as a whole.

The interactive techniques presented in this invention rely more on the perceptual abilities of users to find information. Take for instance the task of looking for a product among a stock of many thousands. The user would look at a representation of all the products in one view. Different categories would be shown as tiled rectangles. The actual products would be shown as dots. The user can then highlight through a keyword, say the keyword pixel, all the products with that keyword in their description. The user would notice that the electronics category and the cameras subcategory have many highlighted dots. Then, using techniques described herein would zoom into the cameras subcategory showing maybe hundreds of products. The dots have become small rectangles and show icons that indicate which ones are video cameras and which ones are photo cameras. There is a subcategory with a lot of the photo cameras highlighted with the pixel keyword. The user would drill to this category and now on the order of a hundred small pictures of digital cameras would be shown. In this case, the user would recognize a picture of one of the cameras that he saw at the store.

The scenario using the techniques introduced in this invention, illustrates a number of advantages over conventional techniques for viewing and looking for information among sets of elements. In contrast to conventional techniques, users can search and view at a hierarchy at the same time. When looking at the search results, they can be presented in the context of their hierarchy and when zooming the user does not have to go all the way to the actual elements to find the elements that he is looking for. A picture, a keyword, an icon, or a combination of these many times suffice. Users do not have to drill down to one subcategory and then drill up and drill back down to another in order view other potentially relevant elements. Because the data elements are organized spatially, lateral moves across the hierarchy are possible.

In accordance to techniques presented herein, other problems encountered in conventional techniques are overcome. As described in previous sections, a common problem is for users to get lost in abstraction hierarchy not being able to find back information that they have looked before. As explained in more detail below, by indicating the user location on the space in a mini-map of the whole view, users know at all times where in the hierarchy they are. In addition, in one embodiment of the present invention we introduce a technique to let users define the abstractions of the sets of elements in a self-organized manner and in this way making it less tedious and less costly the organization of sets of data elements.

In one aspect, the invention provides a computer network user interface. The interface includes a computer network-browsing environment having a graphical spatial context, sometimes organized as a grid, to associate web pages with data to one another and associate control structures to these web pages.

In another aspect, the invention provides a computer network system. The system includes one or more network servers each having a processor and a memory, and one or more network clients connected with the network servers each having a processor, a memory, a display, and a network connector. The system also includes a network user interface having a computer network-browsing environment, which provides a graphical spatial context, sometimes organized as a grid, to associate web pages with data to one another and associate control structures to these web pages.

In still another aspect, the invention provides a method, implemented on a computer system, for providing a computer network-browsing environment. The method involves integrating information from browsing the computer network into a single graphical spatial environment. Also provided is a computer program product for effecting a method in accordance with the present invention.

These and other features and advantages of the present invention will be presented in more detail in the following specification of the invention and the accompanying figures that illustrate by way of example the principles of the invention.

### BRIEF DESCRIPTION OF THE DRAWINGS

The present invention will be readily understood by the following detailed description in conjunction with the accompanying drawings, wherein like reference numerals designate like structural elements, and in which:

FIG. 1 depicts an example of a sequence of Internet browser states for a graphical user interface that has been implemented in accordance with an embodiment of the present invention.

FIG. 2 shows a schematic diagram of 3 zooming levels of tiled IKUs.

FIG. 3 shows a schematic diagram of 3 drilling levels for a set of IKUs.

FIG. 4 illustrates a diagram of the global view concept in accordance to an embodiment of the present invention.

FIG. 5 shows an example graphical user interface that implements a filter function and operates according to an embodiment of the present invention.

FIG. 6 shows an example of a minimap that operates according to an embodiment of the present invention

FIG. 7 illustrates an example of a minimap state for two levels according to one embodiment of the present invention.

FIG. 8 shows a diagram of the process in which XSL stylesheets are applied to markup data of product IKUs to produce views at varying levels of details.

FIG. 9 illustrates the concept for a manual self-organizing abstraction technique presented in this invention.

FIG. 10 shows a diagram illustrating several levels of the image abstraction technique presented in the current invention

FIG. 11 illustrates a flowchart suitable for implementing the extensions to U.S. patent application Ser. No. 09/596,305 in accordance with one embodiment of the present invention.

FIG. 12 shows a network device suitable for implementing the techniques of the present invention.

### DETAILED DESCRIPTION OF THE PREFERRED EMBODIMENTS

Reference will now be made in detail to some specific embodiments of the invention. Examples of these specific embodiments are illustrated in the accompanying drawings. While the invention will be described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

The present invention provides several features, some or all of which may be integrated into computer network browsing systems to provide an improved data browsing experience for users. The concept of an IKU or Intelligent Keeping Unit embodies each of these features. An IKU refers to an atomic unit of data and may refer, for example, to a customer, a job application, a product, a document, a web site, etc. According to, but not limited to, a specific embodiment of the present invention, an IKU may be described by a web page holding data specified using various Internet standards for data interchange such as XML or SOAP and may be served to a web browser, again, using various Internet standards such as HTTP.

The novel navigational features described below leverage the concept of an IKU in the context of browsing sets of them. According to the present invention, sets of IKUs refer to data elements that have the same underlying structure and can be processed in a similar manner. So, for example, for a customer IKU, the set of IKUs refers to a given set of customer data records and for the present invention it is assumed that all of these customer IKUs would described in the same manner.

Zooming

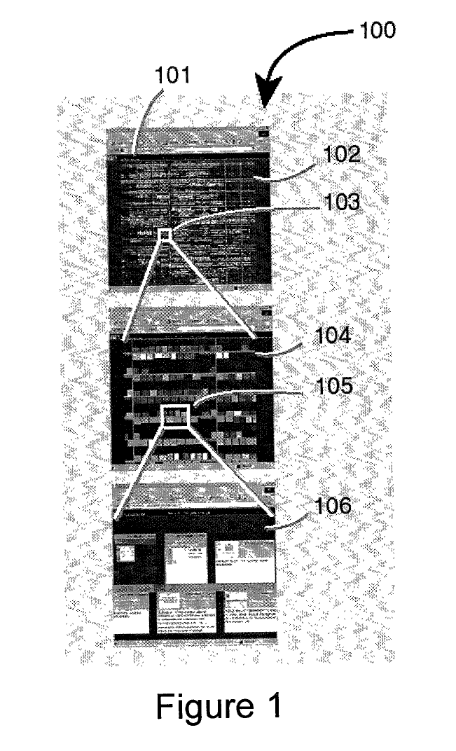

FIG. 1 shows an example of a sequence 100 of Internet browser states for a graphical user interface 101 that has been implemented in accordance with a specific embodiment of the present invention. For the purposes of this application, the IKU is an Internet web site, and according to this specific embodiment, it would be implemented using mechanisms described in U.S. patent application Ser. No. 09/596,305. Global view 102 shows the full view of a landscape sheet where every dot is the zoomed out view of a browser window, as defined in U.S. patent application Ser. No. 09/596,305. Every browser window in this specific embodiment holds the data for an IKU, which according to this application correspond to a web site. For the specific embodiment of the present invention, clicking in region 103 of global view 102 would zoom in the view showing a more detailed view 104 of region 103. Clicking again in region 104 would zoom in again showing a more detailed view 106 of region 105.

As illustrated in this example, the present invention introduces zooming as the user interaction behavior that progressively shows more detailed information of an IKU at each level. In the example of graphical user interface 101, a web site IKU is shown in global view 101 as a colored dot, and then it shows it in view 104 as a colored rectangle, then it shows it in view 106 as browser window with a small summary of the web site and a thumbnail of the home page. It should be noted that using techniques described herein, in other embodiments of the present invention, the example of graphical user interface 101 could show many more levels of zooming and could make use of a combination of icons, colored regions, keywords, images, etc. to progressively show more detailed information about the IKU. The choice of the amount of detail should be function of the screen space (pixels) allocated for every IKU so as to leverage the perceptual abilities of the user to discriminate information among the IKUs in the set.

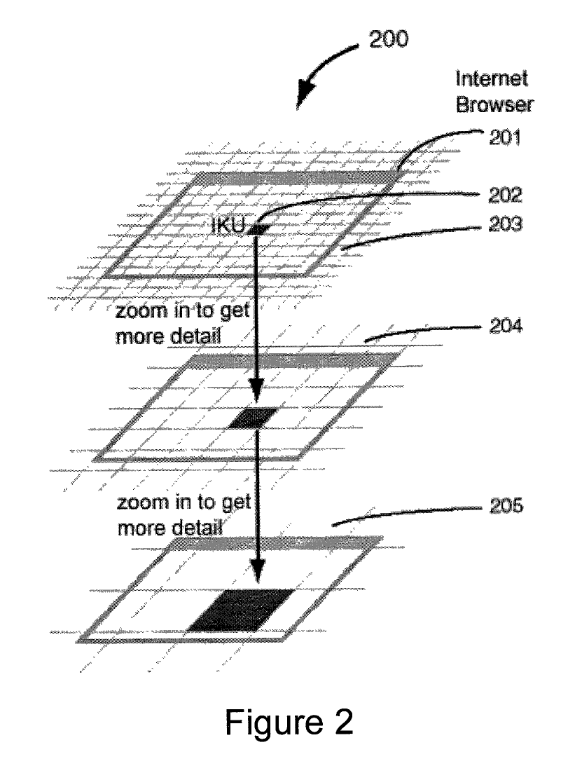

FIG. 2 shows a schematic diagram 200 of 3 zooming levels of tiled IKUs. Notice that there is a one-to-one spatial correspondence between levels 203, 204, and 205 as each tiled browser window associated with an IKU is represented in space. In this conceptual diagram, the browser windows associated with the IKUs are tiled in a grid and in one embodiment would be implemented as tiled browser windows in a landscape sheet as defined in U.S. patent application Ser. No. 09/596,305. This particular embodiment would be referred below as tiled-browser environment. However, in other embodiments as in the example application presented above, the browser windows can be organized in any layout provided that there is a one-to-one spatial correspondence between levels. The space associated with the browser window 202 associated with a particular IKU grows proportionately as the user zooms in to show more detail. As it can be seen in diagram 200, depending on the scale of the tiled browsers and size of the landscape, the user s view through Internet browser 201 may show only a portion of the entire landscape. The interactive techniques presented in U.S. patent application Ser. No. 09/596,305 could be used to pan the view and allow the user to move to other areas of the space at the current level.

Drilling

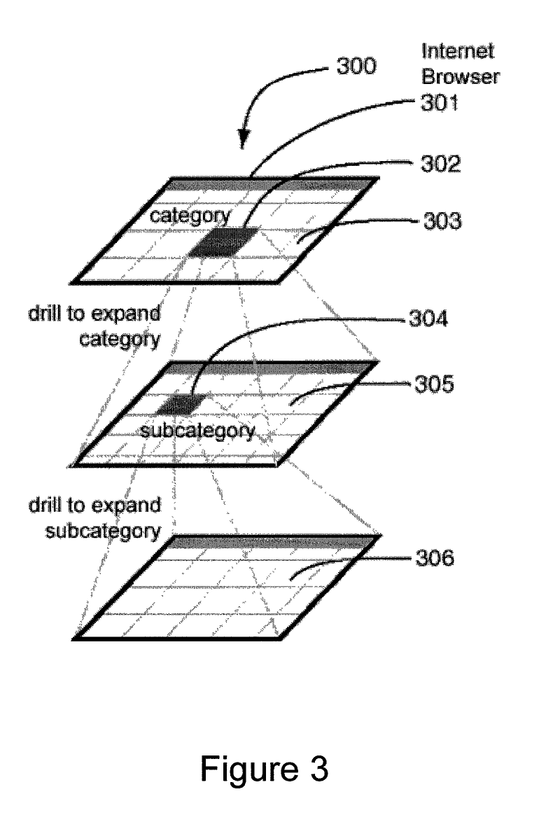

The present invention defines drilling as the user interaction for traversing levels of abstraction for collections of IKUs such as a set of IKUs organized as a hierarchy. FIG. 3 shows a schematic diagram 300 of 3 drilling levels 303, 305 and 306 for a set of IKUs. Each view of Internet browser 301 in diagram 300 represents a level of the hierarchy in which all the categories for that level fill the user s view. So, for example, if the user clicks in category 302, the view would be filled now with view 305 of all the subcategories of category 302. And so on, if the user clicks in subcategory 304, the view would be filled now with view 306 of all the subcategories of category 304. The categories are placed using a flow scheme followed by known packing algorithms to make the layout more compact, algorithms that a person skilled in the art would be able to implement. Size for each category is determined by the size of its sub-tree proportional to the other categories. The user is able to navigate the hierarchy by successively drilling into each subcategory as shown in diagram 300. When drilling, tiled browsers corresponding to categories are abstracted to fit into a designated category area within the user s view of Internet browser 301 as shown in the diagram 300.

Drilling and zooming can be combined as a way to traverse through information. Users can first navigate by drilling through levels in a hierarchy until they have reached a node level, at which point users can then zoom in to get more detailed information on individually represented IKUs within the tiled browser environment.

Global View

A preferred embodiment that operates according to the interactive zooming and drilling techniques of the present invention would have an active map at the top level that would enable a large tiled-browser environment to be fitted in one view. This interactive view would enable users, using techniques described below, to visualize information, to search, to filter and to see alternative views of the information.

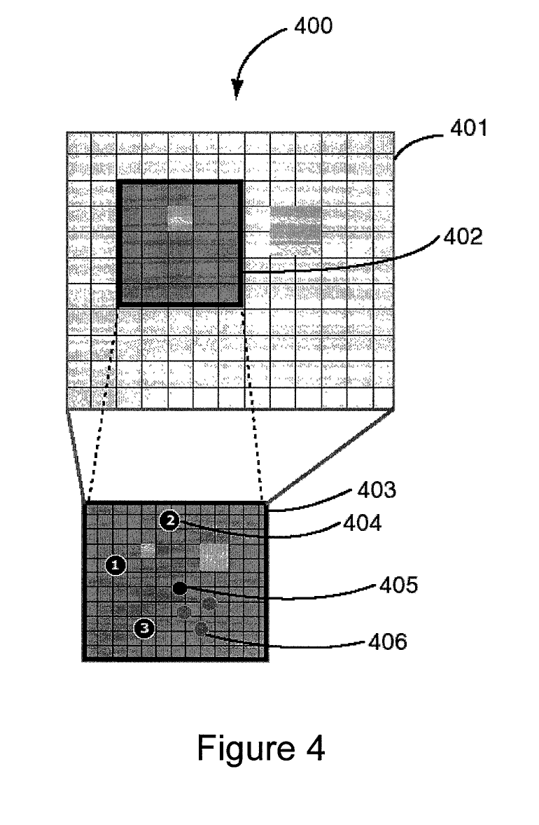

FIG. 4 illustrates a diagram of the global view concept in accordance to an embodiment of the present invention. Diagram 400 shows the actual region 402 of the tiled browser environment 401 that is being displayed by the Internet browser window. In the same diagram, 403 depict the active map that would show the entire tiled browser environment 401 in the Internet browser window.

In this active map, metadata can be overlaid and highlighted at the global view, as well as in multiple levels once the user would either drill or zoom using the interactive techniques described above. For example, category names, IKU attributes, dependencies and data relationships between IKUs, and other meta information can all be shown over the map view. In the case of a collaborative space, as presented in one of the embodiments of U.S. patent application Ser. No. 09/596,305, information on activities in the space can be shown such as the location of users within the space, popular areas, and trails. FIG. 4 depicts a map in which 405 represent the user s current location in the space and 406 indicate other users within the space.

One embodiment of the present invention would support a search function that would work in concert with the active map where by a user would specify search criteria to select particular sets of IKUs, such as for example, typing in keywords when the IKUs are documents. The results matching the search criteria would be highlighted spatially on the map. This technique provides users with several advantages over conventional ways of displaying search results because they can quickly see the results in the context of the larger grouping as well as areas of concentration. FIG. 4 depicts active map 403 overlaid with numbered search results like 404. Using interactive techniques described above, users could, in one embodiment of this technique, drill into an area of the map, by clicking on the map view.

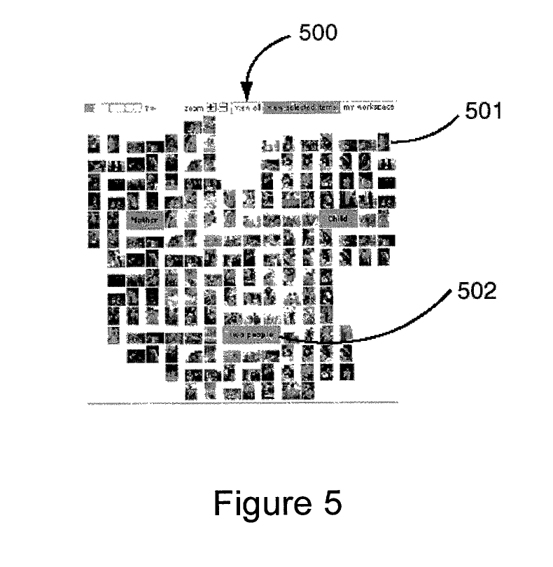

An embodiment of the present invention would support a filter function working in concert with the active map where by users can filter out and view only IKUs matching the selected criteria. By seeing only the subset of IKUs, users are able to see and interact with only the set they care about. FIG. 5 shows an example graphical user interface 500 that implements a filter function and operates according to an embodiment of the present invention. As shown in FIG. 5, the layout of the IKUs, in this case images such as 501, is compressed to show only the selected IKUs. In this specific embodiment, the layout may be organized such that related IKUs may be grouped according to some criteria and label the groupings, such as 502, to help the user figure out what they are looking for.

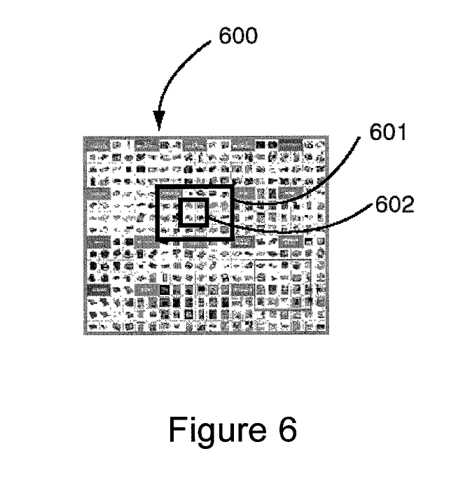

A preferred embodiment of the present invention would have a small conceptual map, herein referred to as minimap, available at all times. This minimap allows the user to have a sense of place and know where they are relative to a larger context and in this way make navigation and context visible. The minimap shows users where they are presently by locating them in the context of the larger space. Since the current and previous levels are shown at all times, users can click to move laterally in the current context as well as the previous one. For example, in a hierarchy, a user can either dive in to a subcategory or jump laterally to another category at the previous level. FIG. 6 shows an example of a minimap 600 that operates according to an embodiment of the present invention. Minimap 600 in FIG. 6 shows the global map view in a small (pixel) footprint. 601 shows conceptually the area that is being taken by the current detail level (gotten to this level either by drilling or by zooming). 602 shows conceptually the area that is being taken by the current view of the Internet browser window.

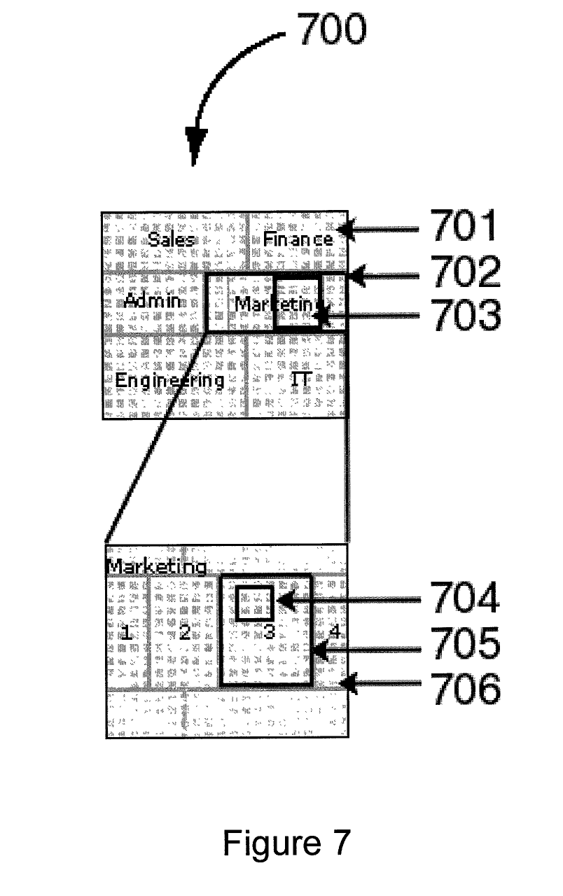

One addition to an embodiment that operates in accordance to the minimap concept as described above is to dynamically show the user s path by displaying the last two levels of the user s navigation scheme in the space. FIG. 7 illustrates an example of a minimap state for two levels according to one embodiment of the present invention. In FIG. 7, 700 shows the transition between the two states of the minimap. 701, 702 and 703 indicate the previous level, the current level and the current view respectively. As the user dives in to another level, the minimap updates to show the user s previous level and it is now 704, 705 and 706 that indicate the previous level, the current level and the current view respectively. By making it dynamic, the minimap acts as a memory trail for the user s path. Moreover, a dynamic map view can reflect non-static hierarchies that are created in real-time, such as real-time grouping of the current data set at each level.

System Components and Characteristics

The characteristics of the components of the system, and the processes by which they operate in preferred embodiments of the invention are described below. As described in further detail below, the system exists in a network environment in which client software runs on an individual user s computer. The client communicates with server software over the computer network. The system described in U.S. patent application Ser. No. 09/596,305 allows for a landscape sheet of tiled browser windows that are presented to an Internet user via a client and a server. The server delivers HTML content and geometric structure to the client per requests based on area. The client uses an HTML rendering engine (e.g., Microsoft Internet Explorer, Netscape Navigator, etc.) to display data. The data is shown in browser windows whose geometric structure is also delivered by the server.

IKUs

The present invention extends the system described in U.S. patent application Ser. No. 09/596,305 with a process that keeps track of IKUs. As introduced in previous sections, an IKU refers to an atomic unit of data. In the system, IKUs are specified by the set of associated stylesheets that are used to process them in order to render the details of browser windows at various levels, by the data records that correspond to every atomic unit of data of an IKU and by the hierarchical structure, if there is one, that may be associated with the IKU set.

Process: Stylesheet Applied Views

A mechanism is described for generating views at each level by means of stylesheet templates applied to markup data of the IKU sets. In one embodiment of the present invention, and as presented above, IKUs may be described as markup data using various Internet standards such as XML or SOAP. A stylesheet, which may be specified, again, using various Internet standards like XSL, may transform every IKU, or group of IKUs, into formats that an Internet browser can show such as HTML or Flash producing a description of the view to be rendered in its corresponding browser window. This technique of the present invention, allows for a flexible mechanism for plugging in customized views and in this way render the views for the different levels of the zooming and drilling interactive techniques of the present invention as described in the previous paragraphs.

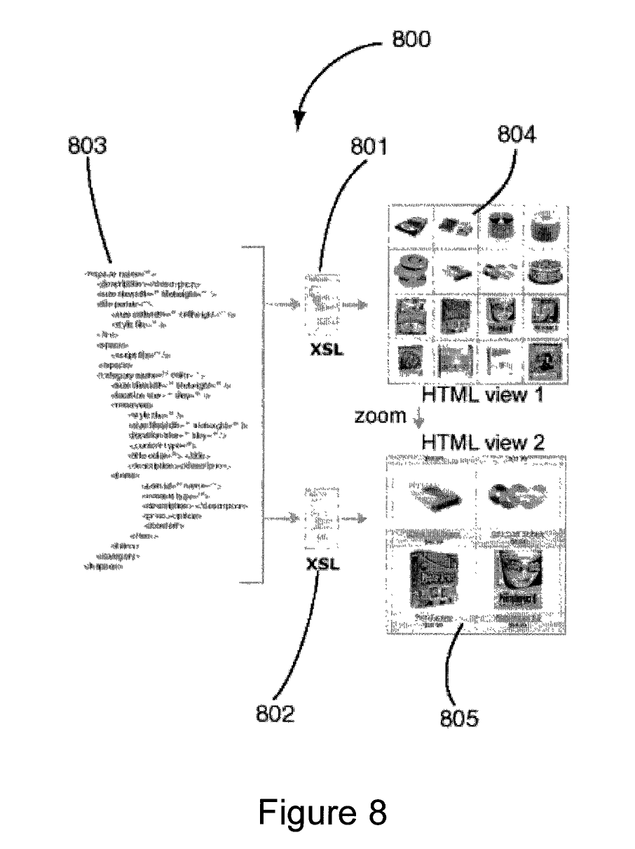

FIG. 8 shows a diagram illustrating the process 800 in which two distinct XSL stylesheets 801 and 802 are applied to markup data 803 of product IKUs to produce two views 804 and 805 respectively at varying zooming levels of details. Stylesheet 804 renders a view in which only small product images are displayed. Stylesheet 805 renders a view in which the product images are larger along with additional information such as product name and price. In this example, more detail information of the products is revealed with each successive level of views. An embodiment of the present invention would use the markup data for IKUs when zooming and use the markup data for the categories of IKUs when drilling.

In accordance to the operation of the mechanism describe above, information changes at any detail level are percolated to all level views. Since changes are reflected at the data source and given that all views are generated from the data source using stylesheets, any data updates to an IKU in one view is reflected in all views representing the IKU. For example, a product IKU marked, as out of inventory may appear grayed-out at multiple levels.

Process: Manual Self-Organizing Abstraction Technique

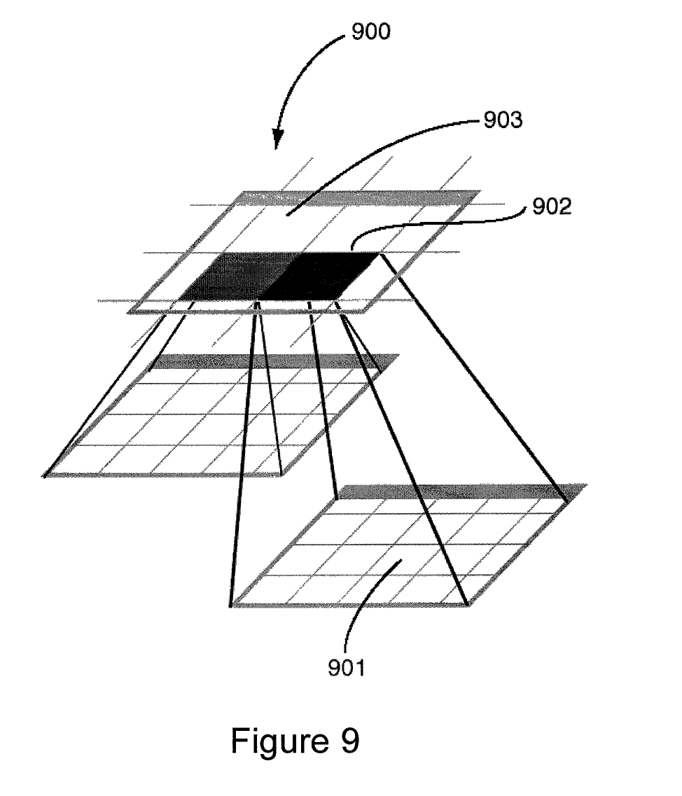

In one embodiment of the present invention as described herein, a manual self-organized mechanism creates a browseable hierarchy of landscape sheets of IKUs that can be viewed using the zooming and drilling interactive techniques as described above. In reference to concepts and techniques described in U.S. patent application Ser. No. 09/596,305, a stylesheet is associated with a landscape sheet holding browser windows of IKUs and this stylesheet would be used to transform the set of IKU data, either as a whole or in a summary format, into a summarized view to be rendered into a browser window of another landscape sheet. As a landscape sheet aggregates summarized views from other landscape sheets into each of its tiled browser windows, effectively, a hierarchy of successively summarized views is produced as this process is applied iteratively. The root landscape sheet is an aggregation of branch landscape sheets, iteratively down to the node. FIG. 9 illustrates in diagram 900 the concept for a manual self-organizing abstraction technique presented in this invention. As shown in diagram 900, landscape sheet 901 gets summarized through a stylesheet (not shown in diagram) into browser window 902 from landscape sheet 903. By using mechanisms described in U.S. Patent Application Serial No. 60/297,206 which allow to create dependencies between landscape sheets and browser windows, and using this hierarchy of landscape sheets as described above, changes in branch landscape sheets could percolate upward to sheets closer to the root.

The technique of the present invention provides a number of advantages, for example, for companies in which there are hierarchical dependencies within the organization. For example, a CEO could have a console view composed of summarized views from each of the divisions within the company. Similarly each division head could have summarized views from each of the managers in the division, and so on down the organization. Any changes to the information at a lower level will percolate upward in the organization dynamically. Such a system of views would allow each level within the company to see information appropriate to their level.

Process: Image Abstraction Technique

One embodiment of the present invention provides for a mechanism to automatically generate a hierarchy of views representing an image space. This technique as described herein may be used to overcome the problem where shrinking a very large space of images into one map view is not a scalable solution; each image in a tiled browser would be barely visible. In accordance to this technique, a hierarchical view is created that progressively shows more images as the user drills into a category.

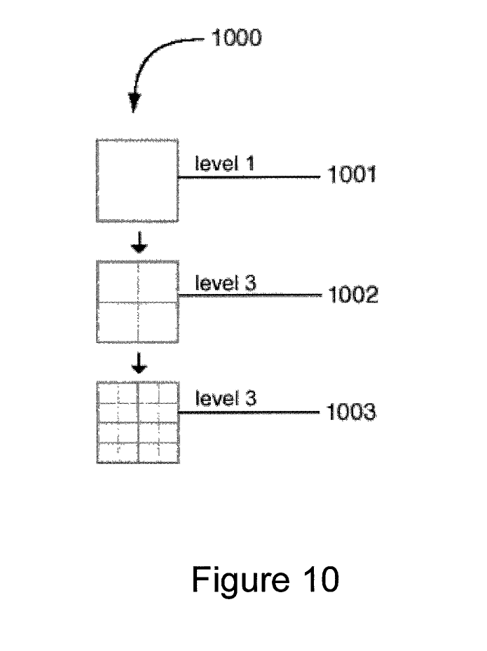

FIG. 10 shows diagram 1000 illustrating several levels of the image abstraction technique presented in the current invention. Each tiled browser is sub-divided into fourths with each successive level of the hierarchy to show more images per category. For example, as shown in diagram 1000, one tile at the top level 1001 becomes 4 tiles at the second level 1002, which becomes 16 tiles at the third level 1003. According to this technique, additional images are progressively revealed as the user drills into a category. In addition, layout is proportionally maintained resulting in strong visual correlation from top to bottom levels. Until the base level, representative images at each level summary can be chosen algorithmically or by some criteria (e.g. best selling products). This technique is especially applicable in the context of U.S. Patent Application Serial No. 60/225,151 where an eCommerce store may have thousands of product images per product category.

System Implementation

The system in U.S. patent application Ser. No. 09/596,305 sends the data (e.g., HTML, XML+XSL) associated with the browser windows that overlap the regions been viewed by a particular client. The implementation for the extensions proposed herein to the system in U.S. patent application Ser. No. 09/596,305 adds additional steps before the actual browser windows in view are rendered within the client.

Process: Generating IKU Views into Browser Windows

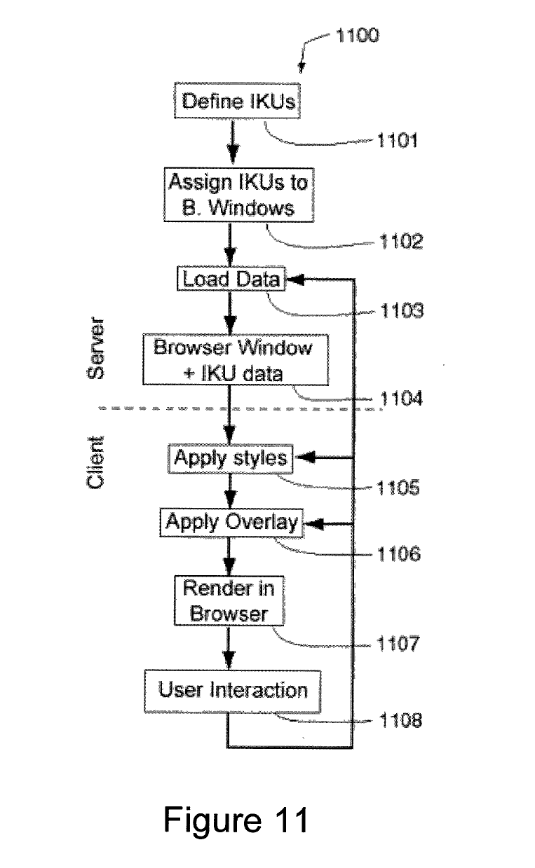

FIG. 11 illustrates a flowchart 1100 suitable for implementing the extensions to U.S. patent application Ser. No. 09/596,305 in accordance with one embodiment of the present invention. As specified in flowchart 1100, the process starts in 1101 by defining an IKU. The IKU is defined by specifying a set of stylesheets that are going to be associated with every detail level. The stylesheets assume that the data records for the IKUs have the same structure. In one embodiment, the data records would be specified as markup data using Internet standards for data interchange such as XML or SOAP. For this embodiment, the data records would have a particular structure that would be defined using Internet standards for defining a structure such as a DTD specification and the stylesheets could use, again, Internet standards for processing markup data such as XSL or JavaScript. This stylesheets describing multiple views are pre-loaded and applied as required on the client, as described below.

The IKUs may have a hierarchical structure associated with them in which case this hierarchy would have to be defined or retrieved from the data sources of the data records. As shown in flowchart 1100, in one embodiment of this invention, every IKU would be assigned a browser window, shown in 1102 in flowchart 1100, in a landscape sheet with a static location and laid out as a tiled grid. Care would be taken to keep all the records from the same category in the hierarchy together in the grid. In an alternative embodiment, IKUs would be assigned to browser windows dynamically every time the user within the client performs a filtering or changing level operation.

As the user view moves from one area to another in the landscape sheet, or changes between levels, the client sends a request to the server for data to a specific area of the landscape sheet. The client manages and keeps track of the view level, user s position, and filtering criteria. 1103 instantiates at the server the data (markup XML-based) associated with the IKUs that correspond to the browser windows overlapping the area of the landscape sheet being viewed. In one embodiment of this invention, the server would package the IKUs records together with their associated browser window data (e.g. plot id, name, attributes, etc.) and serve it to the client (step 1104 in flowchart 1100).

In one embodiment in accordance to an implementation described by U.S. patent application Ser. No. 09/596,305 the server first applies the stylesheets then sends the resulting markup to particular clients. In the implementation described herein, stylesheets describing multiple views are pre-loaded and applied as required on the client to the markup data sent by the server as shown in step 1105 of flowchart 1100. This approach enables the client to change views based on user action without requiring a server request if the data has already been loaded. At the time of rendering, stylesheets (e.g. XSL), describing specific views of the information, are applied to the markup data and rendered in the Browser as shown in step 1107 of flowchart 1100. Metadata information is rendered on an overlay sheet over all browser windows in view (step 1106). Any external changes to the data or changes submitted from the client (step 1108) may result in loading/reloading additional markup data, leading to updated views on the client.

As will be apparent to one of skill in the art, it should be understood that this process is applicable to the implementation of all aspects of the present invention, and this system can be replicated to support any system in accordance with the present invention. Of course, one of skill in the art will recognize that although the process shown in FIG. 11 is one preferred process of the present invention, it is by no means the only process on which the present invention can be implemented. The system may be implemented using other processes effective for accomplishing the features and operation of the system as described herein.

Other Embodiments

Generally, the techniques of the present invention may be implemented on software and/or hardware. For example, they can be implemented in an operating system kernel, in a separate user process, in a library package bound into network applications, on a specially constructed machine, or on a network interface card. In a specific embodiment of this invention, the technique of the present invention is implemented in software such as an operating system or in an application running on an operating system.

A software or software/hardware hybrid implementation of the techniques of this invention may be implemented on a general-purpose programmable machine selectively activated or reconfigured by a computer program stored in memory. Such programmable machine may be a network device designed to handle network traffic, such as, for example, a router or a switch. Such network devices may have multiple network interfaces including frame relay and ISDN interfaces, for example. Specific examples of such network devices include routers and switches. For example, various aspects of the present invention may be implemented on specially configured routers or servers. A general architecture for some of these machines will appear from the description given below. In an alternative embodiment, the techniques of this invention may be implemented on a general-purpose network host machine such as a personal computer or workstation. Further, the invention may be at least partially implemented on a card (e.g., an interface card) for a network device or a general-purpose computing device.

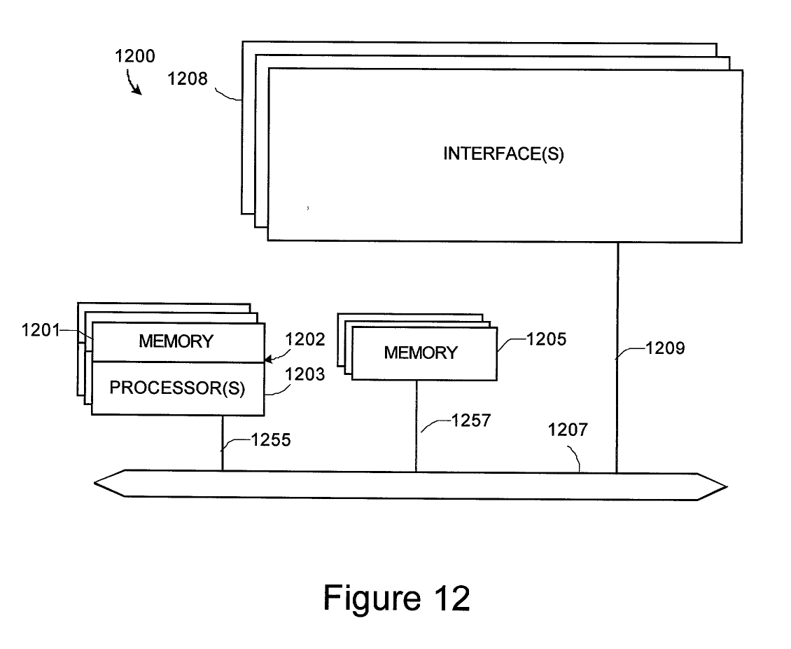

Referring now to FIG. 12, a network device 1200 suitable for implementing the techniques of the present invention includes a master central processing unit (CPU) 1202, interfaces 1208, and a bus 1207 (e.g., a PCI bus). When acting under the control of appropriate software or firmware, the CPU 1202 may be responsible for implementing specific functions associated with the functions of a desired network device. For example, when configured as a server device, the CPU 1202 may be responsible for analyzing packets, encapsulating packets, forwarding packets to appropriate network devices, responding to HTTP requests, etc. The CPU 1202 preferably accomplishes all these functions under the control of software including an operating system (e.g. Windows NT), and any appropriate applications software.

CPU 1202 may include one or more processors 1203 such as a processor from the Motorola family of microprocessors or the MIPS family of microprocessors. In an alternative embodiment, processor 1203 is specially designed hardware for controlling the operations of network device 1200. In a specific embodiment, a memory 1201 (such as non-volatile RAM and/or ROM) also forms part of CPU 1202. However, there are many different ways in which memory could be coupled to the system. Memory block 1201 may be used for a variety of purposes such as, for example, caching and/or storing data, programming instructions, etc.

The interfaces 1208 are typically provided as interface cards (sometimes referred to as line cards). Generally, they control the sending and receiving of data packets over the network and sometimes support other peripherals used with the network device 1200. Among the interfaces that may be provided are Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the master microprocessor 1202 to efficiently perform routing computations, network diagnostics, security functions, etc.

Although the system shown in FIG. 12 illustrates one specific network device of the present invention, it is by no means the only network device architecture on which the present invention can be implemented. For example, an architecture having a single processor that handles communications as well as routing computations, etc is often used. Further, other types of interfaces and media could also be used with the network device.

Regardless of network device s configuration, it may employ one or more memories or memory modules (such as, for example, memory block 1205) configured to store data, program instructions for the general-purpose network operations and/or other information relating to the functionality of the techniques described herein. The program instructions may control the operation of an operating system and/or one or more applications, for example. The memory or memories may also be configured to

Because such information and program instructions may be employed to implement the systems/methods described herein, the present invention relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). The invention may also be embodied in a carrier wave travelling over an appropriate medium such as airwaves, optical lines, electric lines, etc. Examples of program instructions include both machine code, such as produced by a compiler, and files containing higher level code that may be executed by the computer using an interpreter.

According to specific embodiments, the techniques of the present invention may be implemented using well-known, conventional platforms such as, for example, XML, Java, JavaScript and DHTML. Further, according to a specific embodiment, the various aspects of the present invention may be implemented in conventional systems without requiring the use of plug-ins. Further, according to different embodiments, the technology of the present invention may either be adopted as an ASP or via a software license. In a specific embodiment, the technique of the present invention may be implemented on a server system that is accessible by Internet end-users. The technique in the present invention may be configured to be compatible with conventional Internet browser applications such as, for example, Internet Explorer and Netscape Navigator. Thus, according to at least one embodiment, conventional Internet browser applications may be used to implement various aspects of the present invention without requiring use of additional software or plug-ins.

In at least one embodiment, specific user information may be stored locally within a cookie or file on the user's computer. Such information may include, for example, user specific registration information (e.g. username, user ID, password, etc.), and information relating to the user's proxy location during the current and/or previous browsing session with a particular web site.

Conclusion

Although several preferred embodiments of this invention have been described in detail herein with reference to the accompanying drawings, it is to be understood that the invention is not limited to these precise embodiments, and that various changes and modifications may be effected therein by one skilled in the art without departing from the scope of spirit of the invention as defined in the appended claims.

It is claimed

1. A method for effecting multiple related views of data sets and interactive navigation of those multiple views to enable visual, interactive, data-centric, information browsing, searching, and filtering via a data network, the data network including a server system configured to host a web site associated with a first content provider, the data network further including a client system configured or designed to implement a browser application, the browser application being configured or designed to facilitate access to the web site by a first user, the method comprising:
a graphical spatial environment for simultaneous display of structured and unstructured data records from multiple sources;
wherein, said data records can be spatially arranged in manner so as to promote discrimination and comparison
wherein, a plurality of views, at various levels of detail and abstraction, of the spatial environment are dynamically generated using stylesheets to facilitate easier navigation of data sets;
whereby the plurality of views and ease of navigation of data sets enables faster recognition and discrimination of the salient characteristics of particular data at various level of detail and abstraction.
